(19) United States
(12) Patent Application Publication
(10) Pub. No.: US 2018/0055609 A1
(43) Pub. Date: Mar. 1, 2018

(54) ARTICULATOR LOWER TRAY

(71) Applicant: Young Sun CHO, Seoul (KR)

(72) Inventor: Young Sun CHO, Seoul (KR)

(73) Assignees: RH Marketing Inc., Gaithersburg, MD (US); Young Sun CHO, Seoul (KR)

(21) Appl. No.: 15/687,321

(22) Filed: Aug. 25, 2017

(30) Foreign Application Priority Data
Aug. 26, 2016 (KR) 10-2016-0109385

(51) Int. Cl. A61C 9/00; A61C 11/02

(52) U.S. Cl. CPC A61C 9/002; A61C 11/02

(57) ABSTRACT

An articulator lower tray is provided herein. The articulator lower tray as disclosed herein may include a tray body part, an abutment support protrusion parts, and a cover part. The tray body part may include abutment pin holes formed at an interval, the abutment support protrusion parts may be formed at either side of the abutment pin holes, and the cover part may be disposed to cover tops of the abutment pin holes located between the abutment support protrusion parts. The articulator lower tray may further include an abutment pin which may be inserted into one of the abutment pin holes through the cover part.

### CROSS-REFERENCE TO RELATED APPLICATION(S)

This application relates to and claims the benefit of a Korean Patent Application No. 10-2016-0109385, filed Aug. 26, 2016, the entire content of which is incorporated herein by reference in its entirety.

### TECHNICAL FIELD

The present disclosure relates to an articulator lower tray, and more particularly, to an articulator lower tray which can prevent a part of plaster from flowing into an abutment pin hole formed therein and hardening in the abutment pin hole, such that a plaster tooth model can be easily separated and re-coupled to a correct position to obtain a prosthesis with more precision.

### RELATED ART

In general, when a patient has a partially rotten tooth or gum disease, the rotten tooth is replaced with an artificial tooth or treated and covered with a prosthesis made of metal alloy, such that the patient has no trouble in eating food while an influence on normal teeth by the rotten tooth is prevented.

When such a prosthesis is manufactured, the prosthesis must be accurately matched with the position and shape of the rotten tooth in the oral cavity of the patient. Thus, dental clinics put a lot of effort into making a teeth model that matches with the oral cavity of a patient.

In most cases, to manufacture a prosthesis through a teeth model, an operator flattens the bottom surface of the teeth model using a trimmer, drills a hole in the bottom center of each tooth of the teeth model, and inserts and fixes a fixing pin into the hole using an instant glue. Then, the operator injects dental plaster into a predetermined shape of cast and hardens the injected plaster to fix the bottom of the teeth model having the fixing pin inserted therein, and then forms a base plate on which the teeth model having the fixing pin inserted therein is seated. Then, the operator engages the upper and lower teeth models with an articulator, and fixes the upper and lower teeth models to the articulator using a cast. Then, the operator cuts a portion of the teeth model fixed to the top of the base plate, the portion corresponding to a specific tooth requiring a prosthesis, and manufactures a prosthesis using the cut portion of the teeth model.

Such a prosthesis manufacturing operation using the fixing pin requires a long operation time because a preparation for the teeth model is complex, and the operator may have difficulties in learning the skills of the complex teeth model preparation (pin operation and model operation). Furthermore, once a pin and a base plate are formed, the pin and the base plate cannot be reused for another operation. In this case, a problem of material waste inevitably occurs.

In order to obtain a prosthesis and artificial tooth which are optimized for a tooth structure of a patient, dental clinics and dental laboratories use an articulator as one of dental treatment instruments for providing the optimized tooth prosthesis or artificial tooth. The articulator enables an operator to check the tooth structure of the patient, the upper and lower jaw structures that implement a temporomandibular joint motion of the patient, and an occlusal state and mastication state of the patient. At the initial stage, the articulator had been made of a solid and semi-permanent metallic material. However, since the articulator includes upper and lower jaw articulator members coupled to each other, the articulator degrades the workability, is difficult to use and deal with, and has a high weight and price. Thus, disposable products made of plastics are used as an alternative for overcoming the above-described problems.

The operator inserts a metallic pin into a pin fixing hole formed at the top surface of a base member of the articulator, seats a teeth model formed of dental plaster on the top surface of the base member having the pin inserted therein using a teeth impression of a patient, and then hardens the teeth model, thereby completing the teeth model of the patient.

Then, when the patient's teeth model is hardened on the base member, the operator performs a finishing operation of removing the plaster which has flown down along the outside of the base member when the teeth model was formed, through a grinding operation. After the finishing operation, the operator performs a sawing operation for separating a tooth model corresponding to the tooth requiring a treatment from the entire teeth model.

The teeth model for treatment, separated from the entire teeth model during the sawing operation, has a bottom surface fixed to the top surface of the base member, a pin coupled to the base member and a pin structure protruding from the top surface of the base member. Thus, the teeth model for treatment is not easily separated from the base member even though the operator performs the sawing operation for separating the tooth model from the entire teeth model. At this time, in order to separate the tooth model for treatment from the base member, the operator performs a separate operation of inserting a sharp instrument between the base member and the tooth model as a hardened plaster model, and separating the tooth model fixed to the top surface of the base member.

During such a process, the tooth model for treatment is not easily separated from the base member because the bottom surface of the tooth model is fixed to the top surface of the base member and the pin structure formed at the top surface of the base member through a flat-surface contact or multi-surface contact. Furthermore, when the operator applies an excessive force, the tooth model may be broken or damaged, which makes it inconvenient to perform the separation operation while degrading the operation efficiency.

In order to solve the problems, Korean Patent Publication No. 10-2013-73511 published on Jul. 3, 2013 disclosed an articulator for a dental technician and a teeth model fixing pin used for the same, which are capable of improving operation efficiency when a teeth model is formed. However, when a teeth model is formed, a part of plaster injected through the top of a base member may flow into a pin fixing hole to which a teeth model fixing pin is not inserted, and then harden in the pin fixing hole. In this case, the plaster flowing into the pin fixing hole and hardening therein may be broken with a crack, during a process of separating the teeth model.

Such a problem may cause another problem in which an incorrect prosthesis is obtained because the separated teeth model is not located at a correct position while being relocated.

### SUMMARY

Various examples are directed to an articulator lower tray which is configured to prevent a part of plaster from flowing into a pin fixing hole in which a metallic pin is not inserted, the plaster being injected through a top surface of a base member, and prevent an occurrence of any crack or fracture during a process of separating a hardened teeth model, thereby facilitating a prosthesis operation to obtain a precise prosthesis.

In the example, an articulator lower tray may include: a tray body part having abutment pin holes formed at an interval therein; a plurality of abutment support protrusion parts formed at either side of the abutment pin holes; a cover part formed to cover tops of the plurality of the abutment pin holes; and an abutment pin inserted into the abutment pin hole through the cover part.

In an aspect of the present disclosure, the tray body part may include a locking guide formed at one side thereof so as to protrude in a horizontal direction and a finger hinge part formed at the other side thereof so as to protrude in an obliquely upward direction, the locking guide having a locking hole into which an occlusion induction pin is inserted.

In an aspect of the present disclosure, the finger hinge part of the articulator lower tray may include: a hinge filter support piece formed at the other side of the tray body part and protruding in the horizontal direction; a hinge insertion finger supported by one of outer corners of the hinge finger support piece, inclined in an obliquely upward direction, and having a hinge insertion groove formed at the top thereof, wherein the hinge insertion groove is formed by cutting the upper portion of the hinge insertion finger; and a hinge finger supported by the other of the outer corners of the hinge finger support piece, inclined in an obliquely upward direction, and having a cap hinge and finger stopper formed at the top thereof.

In an aspect of the present disclosure, the hinge finger support piece may have a stop induction groove formed between the hinge insertion finger and the hinge finger.

In another aspect of the present disclosure, the abutment pin hole may have a cross-sectional surface of which the area gradually decreases from top toward bottom, and include a pin hole expansion portion formed at the edge of an upper entrance thereof.

In another aspect of the present disclosure, the abutment pin hole may have any one cross-sectional surface among a circular cross-sectional surface, an elliptical cross-sectional surface and a polygonal cross-sectional surface, and the cross-sectional surface has an area that gradually decreases from top toward bottom.

In an aspect of the present disclosure, the abutment support protrusion part may be formed in a liner shape connected from the abutment pin hole at one side to the abutment pin hole at the other side, or composed of a plurality of pieces arranged in the same intervals as the abutment pin holes.

In an aspect of the present disclosure, the cover part may comprise a synthetic resin film.

In as aspect of the present disclosure, the cover part may be disposed on a top surface of the tray body part having the abutment pin holes formed therein through an adhesive layer formed on the bottom of the synthetic resin film.

In an aspect of the present disclosure, the cover part may have a plurality of pin insertion guides formed in the synthetic resin film having a band shape, and matched with the center of each of the abutment pin holes formed in the tray body part.

In an aspect of the present disclosure, each of the pin insertion guide may include a cut line part formed by cutting the synthetic resin film in the vertical direction.

In an aspect of the present disclosure, the cut line part may have a line or wave shape crossing a portion located over an accompanying abutment pin hole.

In an aspect of the present disclosure, the pin insertion guide may be torn into two or more portions through the cut line part formed by cutting the synthetic resin film in the vertical direction.

In an aspect of the present disclosure, the pin insertion guide may include: a film cut part formed by cutting the synthetic resin film in the vertical direction along an edge of the abutment pin hole; and a film non-cut part corresponding to a portion which is not cut in the corresponding portion of the synthetic resin film.

In an aspect of the present disclosure, pairs of the film cut part and the film non-cut part may be repeatedly formed, and the film cut part may have a circumferential length less than the half of the circumferential length of the abutment pin hole.

In an aspect of the present disclosure, the abutment pin may include: a pin body; and a pin head formed at a top of the pin body, having a smaller cross-sectional area than the pin body, and extended upward by a predetermined length. The pin body and the pin head may be formed as one body.

In an aspect of the present disclosure, the pin body may be formed in a shape of which the cross-sectional area gradually decreases from top toward bottom.

In an aspect of the present disclosure, the pin body may have any one cross-sectional shape among a circular cross-sectional shape, an elliptical cross-sectional shape and a polygonal cross-sectional shape, and is formed in a shape of which the cross-sectional area gradually decreases from top toward bottom.

In an aspect of the present disclosure, the pin head may be configured to include a plurality of pin head grooves formed at a predetermined interval from top toward bottom or from bottom toward top along the circumference thereof.

### BRIEF DESCRIPTION OF THE DRAWINGS

A more detailed understanding may be obtained from the following description in conjunction with the accompanying drawings.

FIG. 1 is a perspective view illustrating that an articulator upper tray and an articulator lower tray are coupled to each other in an aspect of the present disclosure.

FIG. 2 is a perspective view illustrating that the articulator upper tray and the articulator lower tray separated in an exploded view in an aspect of the present disclosure.

FIG. 3 is a perspective view illustrating that the articulator upper tray and the articulator lower tray are coupled to each other and in an unfolded state in an aspect of the present disclosure.

FIG. 4 is a perspective view illustrating the inside and outside of a portion to which abutment pins are coupled while the articulator upper tray and the articulator lower tray are coupled to each other in an unfolded state in an aspect of the present disclosure.

FIG. 5 is a perspective view illustrating a process in which the abutment pins are coupled while the articulator upper tray and the articulator lower tray are coupled to each other and in an unfolded state in an aspect of the present disclosure.

FIG. 6 is a perspective view illustrating an example embodiment in an exploded view in an aspect of the present disclosure.

FIG. 8 illustrates various examples of a cover part in an aspect of the present disclosure.

FIGS. 8A to 8C are cross-sectional views illustrating a process in which the abutment pin is coupled to a portion of the articulator lower tray in an aspect of the present disclosure.

FIG. 9 is a side cross-sectional view illustrating the abutment pins coupled to the articulator lower tray, while the articulator upper tray and the articulator lower tray are unfolded in an aspect of the present disclosure.

FIG. 10 is a partial cross-sectional view illustrating an abutment pin coupled to the articulator lower tray in an aspect of the present disclosure, when the articulator upper tray is coupled to the articulator lower tray in a folded state.

FIG. 11 is a perspective view illustrating that the abutment pins are coupled to the articulator lower tray in an aspect of the present disclosure, when the articulator upper tray and the articulator lower tray are coupled to each other and in a folded state.

FIG. 12 is a cross-sectional view illustrating an abutment pin coupled to a portion of the articulator lower tray in an aspect of the present disclosure.

### DETAILED DESCRIPTION

The detailed description of illustrative examples will now be set forth below in connection with the various drawings. The description below is intended to be exemplary only and in no way limit the scope of the claimed invention. For example, it is intended to provide a detailed example of possible implementation(s), and is not intended to represent the only configuration in which the concepts described herein may be practiced. As such, the detailed description includes specific details for the purpose of providing a thorough understanding of various concepts, and it is noted that these concepts may be practiced without these specific details. In some instances, well known structures and components are shown in block diagram form in order to avoid obscuring such concepts. It is also noted that like reference numerals are used in the drawings to denote like elements and features.

While for the purpose of simplicity the methodologies or aspects may be described herein as a series of steps or acts, it is to be understood that the claimed subject matter is not limited by the order of steps or acts, as some steps or acts may occur in different orders and/or concurrently with other acts from that shown and described herein. Further, not all illustrated steps or acts may be required to implement various methodologies or aspects according to the present disclosure disclosed herein.

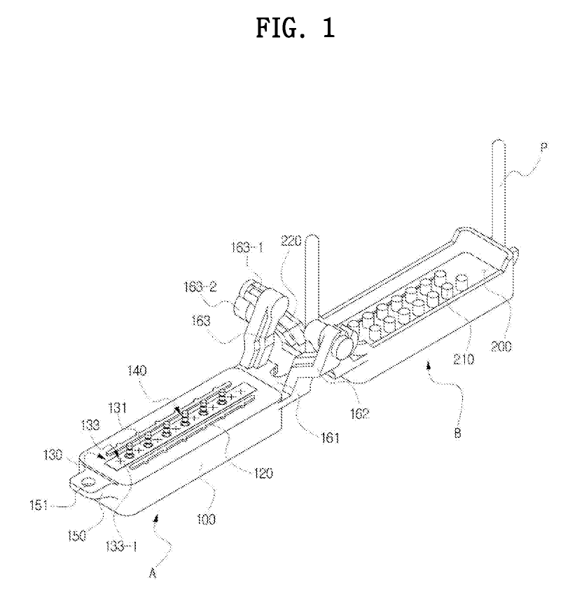

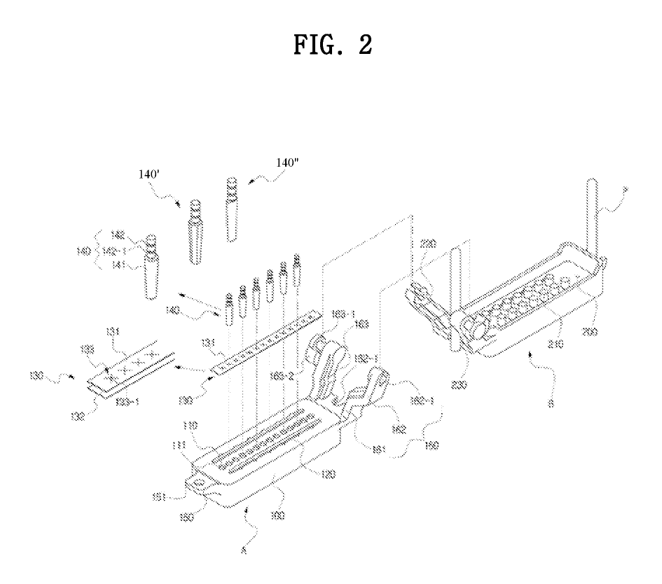

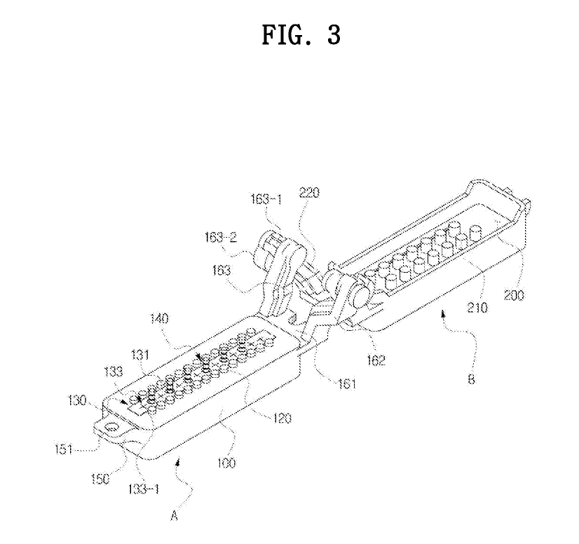

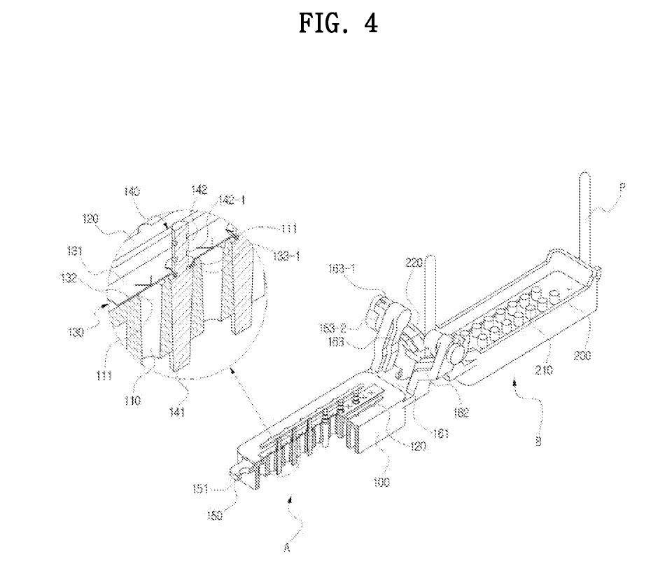

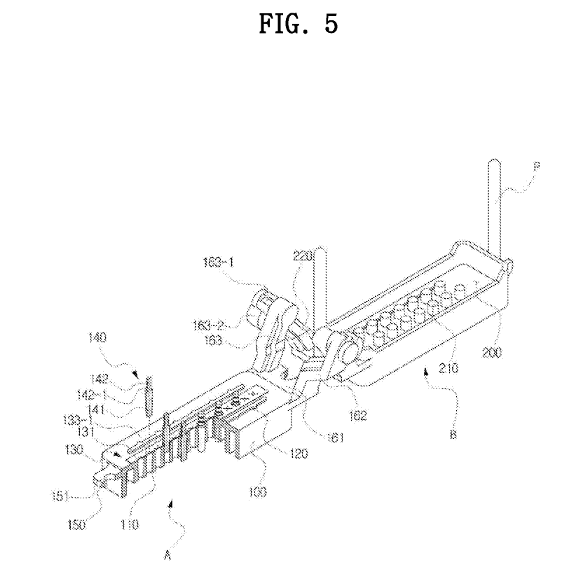

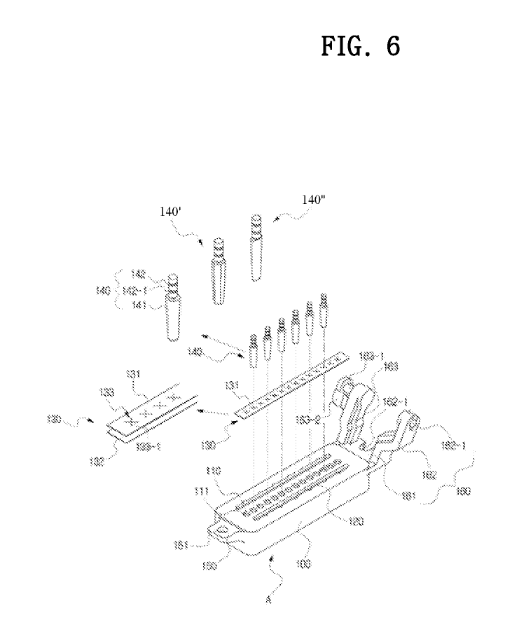

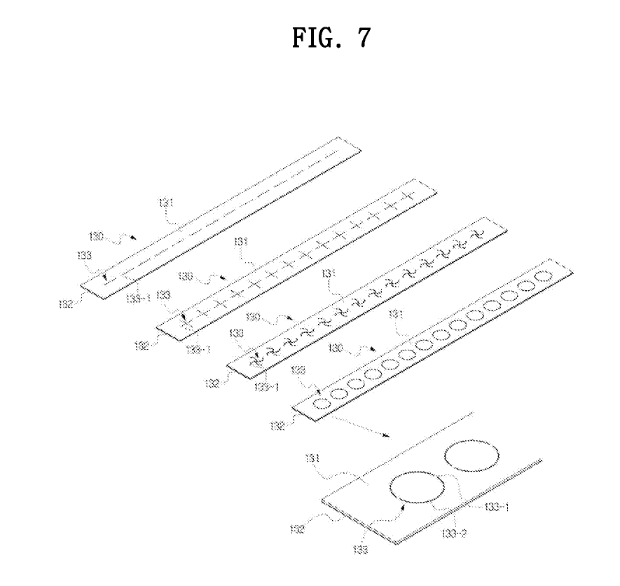

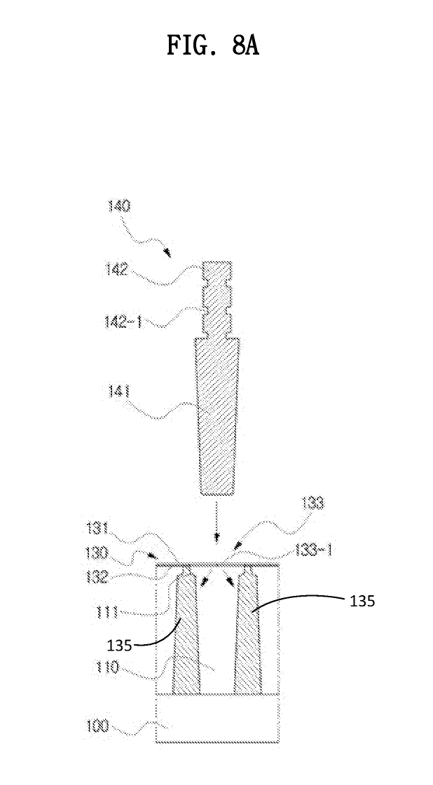

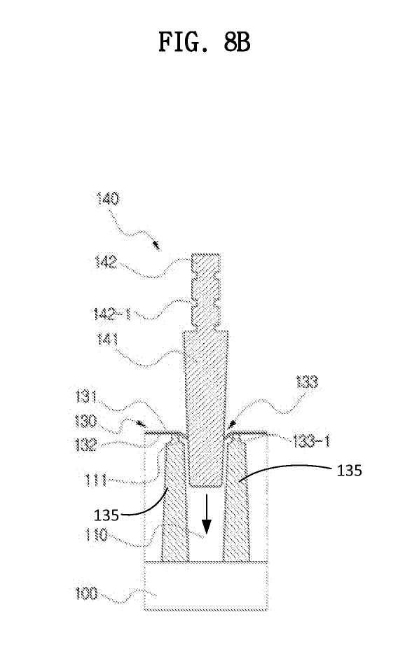

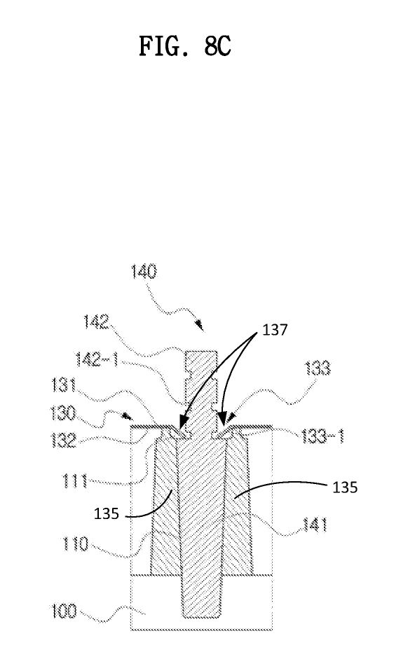

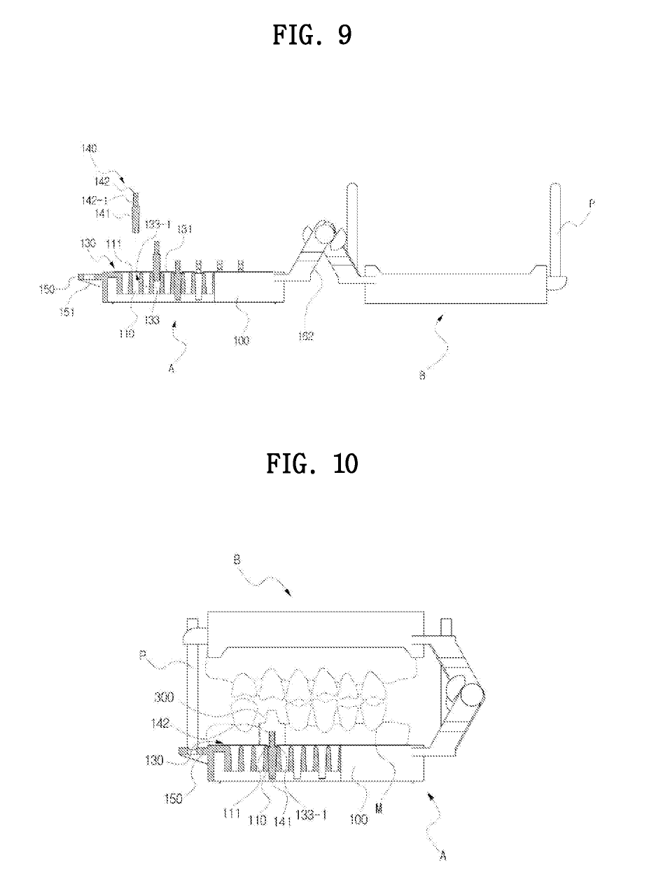

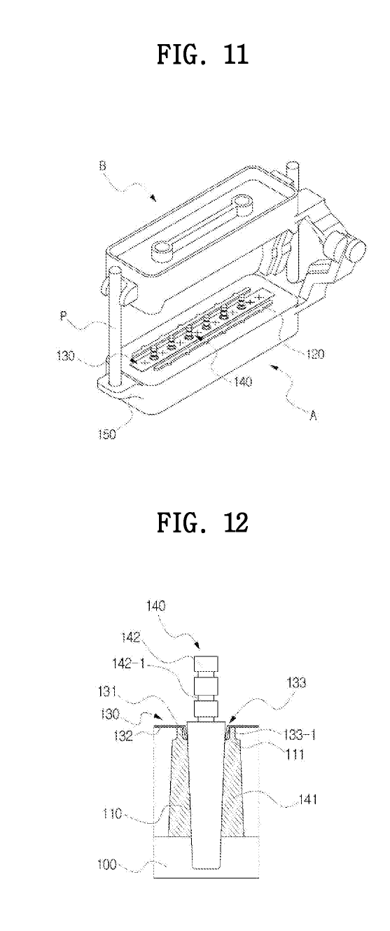

FIG. 1 is a perspective view illustrating that an articulator lower tray A and an articulator upper tray B, according to an aspect of the present disclosure, are coupled and an unfolded position. FIG. 2 is a perspective view illustrating that the articulator upper tray B and the articulator lower tray A, according to an aspect of the present disclosure, are unfolded and separated in an exploded view. FIG. 3 is a perspective view illustrating another example of the articulator lower tray A in an aspect of the present disclosure. FIG. 4 is a perspective view illustrating an inside and an outside of a portion to which abutment pins are coupled while the articulator lower tray A and the articulator upper tray B are coupled and position in an unfolded state in an aspect of the present disclosure. FIG. 5 is a perspective view illustrating a process in which the abutment pins are coupled to the articulator lower tray, while the articulator upper tray and the articulator lower tray are unfolded in an aspect of the present disclosure. FIG. 6 illustrates an example of the articulator lower tray B in an exploded view. FIG. 7 illustrates various examples of a cover part 130 in an aspect of the present disclosure. FIGS. 8A to 8C are cross-sectional views illustrating a process in which the abutment pin 140 is coupled or inserted into the abutment insertion pin hole 110 in an aspect of the present disclosure. FIG. 9 is a side cross-sectional view illustrating the abutment pins 140 coupled to the articulator lower tray B, while the articulator upper tray A and the articulator lower tray B are coupled and in an unfolded state in an aspect of the present disclosure. FIG. 10 is a partial cross-sectional view illustrating that the abutment pin is coupled to the articulator lower tray A in an aspect of the present disclosure, and the articulator upper tray B is folded over the articulator lower tray A. FIG. 11 is a perspective view illustrating that the abutment pins are coupled to the articulator lower tray in an aspect of the present disclosure, and the occlusion induction pin P is inserted. FIG. 12 is a cross-sectional view illustrating that an abutment pin 140 is coupled to a portion of the articulator lower tray B in an aspect of the present disclosure.

Referring back to FIG. 1, in the example shown, the articulator lower tray A and the articulator upper tray B are coupled together in an unfolded or open mode. FIG. 2 illustrates an exploded view of the example shown in FIG. 1. The articulator lower tray A may be configured to prevent a part of plaster from flowing into an abutment pin hole 110 formed in a tray body part 100 and hardening therein during a process of forming a plaster teeth model, thereby enabling that separation can be smoothly performed to obtain a high-quality prosthesis. As illustrated in FIGS. 1 to 2, in an aspect of the present disclosure, the articulator lower tray A may include the tray body part 100, an abutment support protrusion part 120, a cover part 130 and an abutment pin 140.

As shown in FIGS. 1 and 2, the articulator lower tray A may include a substantially similar or same shape as that of the articulator upper tray B, and is hinge-coupled to the articulator upper tray B having a plurality of protrusions 210 disposed in an internal space 200 of the articulator upper tray B. Through hinge parts such as 160 and/or 230, the articulator lower tray A and the articulator upper tray B may be coupled to each other and be folded and unfolded, and easily detached from and/or attached to each other or easily separated from and/or coupled to each other.

In an aspect of the present disclosure, the tray body part 100 of the articulator lower tray A may be injection-molded of a synthetic resin, and may include a rectangular shape as a whole. The tray body part 100 may include a plurality of abutment pin holes 110 arranged at an interval on a top surface thereof, such that an abutment 300 (as shown in FIG. 10) can be stably supported, easily separated, and re-coupled to a correct position. Further, one or more abutment pins 140 may be inserted into one or more abutment pin holes corresponding to the abutment 300 which needs to be covered with a prosthesis at a specific position among a plurality of normal teeth.

Further, in another aspect of the present disclosure, the tray body part 100 may include a locking guide 150 formed at one side thereof, as shown in FIGS. 1 and 2. In the example, the locking guide 150 may include a locking hole 151 into which a lower end portion of an occlusion induction pin P that may be fixed to the upper tray B is inserted while the articulator upper tray B is coupled to the articulator lower tray A and are folded together. While the articulator upper tray B is easily folded, the tray body part 100 of the articulator lower tray A may prevent the articulator upper tray B from being folded more than necessary or unfolded in an opposite direction, in order to obtain a plaster teeth model having a correct shape.

Further, the locking guide 150 may be formed in a longitudinal direction of the tray body part 100, while protruding in a horizontal direction.

The tray body part 100 may include a finger hinge part 160 formed at the other side thereof, facing the locking guide 150. The finger hinge part 160 may protrude in an obliquely upward direction. The finger hinge part 160 may be configured to be detachably and rotatably coupled to an upper finger hinge part 220 which is formed in the articulator upper tray B while having a symmetrical shape.

The finger hinge part 160 may prevent the articulator upper tray B from being misaligned with the articulator lower tray A while the articulator upper tray B is folded over the articulator lower tray A, and may include a hinge finger support piece 161, a hinge insertion finger 162 and a hinge finger 163.

The hinge finger support piece 161 may prevent an occurrence of interference when the articulator lower tray A and the articulator upper tray B are folded and unfolded, and assure a wider space while plaster is poured and hardened in the articulator lower tray A. Thus, the operation can be smoothly performed, and the hinge insertion finger 162 and the hinge finger 163 can be stably supported even though the hinge insertion finger 162 and the hinge finger 163 are spread in obliquely upward directions.

In an aspect of the present disclosure, the hinge finger support piece 161 may be formed at the other side of the tray body part 100 so as to protrude in the horizontal direction.

The hinge insertion finger 162 has a lower end portion supported by one of outer corners of the hinge finger support piece 161, is inclined in an obliquely upward direction, and includes a hinge insertion groove 162-1 formed at the top thereof, the hinge insertion groove 162-1 being formed by cutting the upper portion of the hinge insertion finger 162. Thus, a cap hinge 230 formed in the articulator upper tray B can be fitted and coupled to the hinge insertion groove 162-1, and rotated while a separation in a reverse direction is prevented.

The hinge finger 163 is formed in a symmetrical shape with the hinge insertion finger 162 facing the hinge finger 163, has a lower end portion supported by the other of the outer corners of the hinge finger support piece 161, is inclined in an obliquely upward direction, and includes a cap hinge 163-1 and finger stopper 163-2 formed at the top thereof. The hinge finger 163 can prevent the articulator upper tray B from being folded or unfolded more than necessary, while the upper finger hinge part 220 formed in the articulator upper tray B is rotatably fitted and coupled to the cap hinge 163-1.

The hinge finger support piece 161 has a stop induction groove 161-1 formed between the hinge insertion finger 162 and the hinge finger 163, such that the folded state can be continuously maintained to harden the plaster teeth model into a correct state.

The abutment support protrusion part 120 can secure a sufficient support force while plaster injected into the upper portion of the tray body part 100 hardens, thereby preventing a deformation of the plaster teeth model before the plaster hardens, but also preventing a deformation of the plaster teeth model during a process of cutting the plaster teeth model. The abutment support protrusion part 120 is formed in a protruding shape at either side of the abutment pin hole 110 so as to prevent an interference with the abutment pin 140.

The abutment support protrusion part 120 may be formed in a liner shape connected from the abutment pin hole 110 at one side to the abutment pin hole 110 at the other side along a longitudinal direction at a top surface of the tray body part 100 of the articulator lower tray A. In another aspect of the present disclosure, the abutment support protrusion part 120 may comprise a plurality of pieces arranged at same intervals as the abutment pin holes 110 along the longitudinal direction at the top surface of the tray body part 100 of the articulator lower tray A. In the present example, the abutment support protrusion part 120 is located at the top surface of the tray body part 100, and formed in a line shape at either side of the abutment pin hole 110 along the longitudinal direction. As illustrated in FIG. 3, however, the abutment support protrusion part 120 may comprise a plurality of pieces formed in a dot shape, in addition to the line shape.

As shown in FIG. 3, when the abutment support protrusion part 120 comprises the plurality of pieces formed in a dot shape, usage of the material can be reduced, and a sawing operation can be easily performed during a process of cutting and separating only an abutment.

Referring back to FIG. 2, the abutment pin hole 110 can prevent the abutment pin 140 from being inserted to a predetermined depth or more, and allow an operator to easily separate the abutment pin 140 in a reverse direction from a bottom to a top of the tray body part 100. The abutment pin hole 110 may be formed in a tapered shape of which a cross-sectional area thereof may gradually decrease from the top to the bottom of the tray body part 100.

Further, as shown in FIG. 4 (and FIGS. 8A-9C), the abutment pin hole 110 may include a pin hole expansion portion 111 formed at an upper entrance corresponding to a top surface of the tray body part 100, and a pin hole formed by side body 135. The pin hole expansion portion 111 includes a cross-sectional area that gradually increases towards the upper entrance corresponding to the top surface of the tray body part 100. In an aspect of the present disclosure, the pin hole expansion portion 111 may prevent an incorrect coupling which may occur when a part of a pin insertion guide 133 formed in a synthetic resin film 131 of the cover part 130 is torn out by the abutment pin 140, inserted into the pin hole expansion portion 111, and caught between the abutment pin hole 110 and the abutment pin 140 such that the abutment pin 140 is not correctly inserted into the abutment pin hole 110. That is, the pin hole expansion portion 111 is configured in such a way that the abutment pin 140 is correctly disposed into the abutment pin hole 110. Further, a space 137 formed by the pin hole expansion portion 111 (for example, as shown in FIG. 8C) is configured such a way that the part of the pin insertion guide 133 does not get disposed between the abutment pin hole 110 and the abutment pin 140. Thus, in an aspect of the present disclosure, since an incorrect coupling can be prevented, it is possible to prevent an occurrence and formation of a prosthesis with low precision.

The abutment pin hole 110 has a circular cross-sectional surface such that the abutment pin 140 can be simply inserted into the abutment pin hole 110 from the top to the bottom. The circular abutment pin hole 110 is configured to allow an operator to easily insert or couple the abutment pin 140 only by inserting the abutment pin 140 into the abutment pin hole 110 with his fingers while ignoring a direction of the abutment pin 140.

In the example, as mentioned above, the abutment pin hole 110 includes a circular cross-sectional surface. However, the abutment pin hole 110 may have an elliptical cross-sectional surface or polygonal cross-sectional surface, in addition to the circular cross-sectional surface to match the corresponding shape of the abutment pin 140. In such cases, the manufacturing process may become more complex than when the abutment pin hole 110 has a circular cross-sectional surface. When the abutment pin 140 having the same cross-sectional shape as the abutment pin hole 110 is inserted, the abutment pin 140 can be prevented from rotating in a direction perpendicular to an axis thereof, and fitted to a correct position during an assembling process. As such, a more precise plaster teeth model can be obtained.

In an aspect of the present disclosure, the abutment pin hole 110 having any one cross-sectional surface among the circular, elliptical and polygonal cross-sectional surfaces may be formed in a tapered shape of which the cross-sectional area gradually decreases from the top to the bottom of the tray body part 100 (or the body 135). Thus, in the example, the abutment pin 140 inserted into the abutment pin hole 110 may be disposed to a predetermined depth. Thus, when the abutment pin 140 is separated from the abutment pin hole 110, as shown in FIG. 5, the abutment pin 140 can be smoothly separated in a reverse direction from the bottom to the top of the tray body part 100. Alternatively, the abutment pin 140 may be inserted through the abutment pin hole 110 as shown in FIG. 8C.

In the example, the cover part 130 may be configured to prevent an occurrence of interference while assisting the abutment pin 140 to be easily inserted into the abutment pin hole 110 formed in the tray body part 100, and prevent plaster from flowing into the abutment pin hole 110 or another abutment pin hole 110 into which the abutment pin 140 is not inserted or fitted. Further, the cover part 130 may be configured to cover the top of the abutment pin hole 110 disposed between the abutment support protrusion parts 120.

In an aspect of the present disclosure, the cover part 130 may include a synthetic resin film 131, and may be formed in a thin film shape with a small thickness. As a result, while the plaster hardens, it is maintained such that the plaster substantially adheres to the top surface of the tray body part 100 of the articulator lower tray A.

In another aspect of the present disclosure, as shown in FIG. 6, the cover part 130 may include an adhesive layer 132 disposed on a bottom surface of the synthetic resin film 131, facing the top surface of the tray body part 100. The cover part 130 may be attached or glued to the top surface of the tray body part 100 having the abutment pin hole 110 formed therein through a predetermined adhesive force, such that a separation of the cover part 130 from the tray body part 100 can be prevented. That is, in one implementation, the cover part 130 may be attached through the adhesive layer 132 installed in the form of a thin sticker through which the abutment pin 140 can be easily inserted into the abutment pin hole 110. Further, the adhesive layer 132 may be configured to serve as a barrier film for preventing plaster from flowing into the abutment pin hole 110. In the present disclosure, the word “sticker” is used herein to generally mean a thin layer or film with an adhesive material on its surfaces (on either one or both surfaces) of the thin layer, and may be in the form of a single layer or multiple layers.

Also, in another implementation, the cover part 130 may not include the adhesive layer 132, which is a separate from the synthetic resin film 131. That is, an adhesive material may be applied to the synthetic resin film 131 and the cover part 130 may be in the form of a single layer film or the like. Alternatively, the synthetic resin film 131 and the adhesive layer 132 may be combined to form an integrated cover part 130. In such a case, the cover part 130 may include an adhesive material on a bottom surface of the cover part 130.

In the example, the cover part 130 allows the abutment pin 140 to be easily inserted or coupled through the abutment pin hole 110, and thus prevents an interference with the abutment support protrusion parts 120 installed at both sides of the abutment pin hole 110. Further, the cover part 130 may include the synthetic resin film 131 formed in the shape of a band having a width smaller than the interval between the abutment support protrusion parts 120 formed at both sides of the abutment pin hole 110, and the synthetic resin film 131 includes a pin insertion guide 133 formed at a position which substantially corresponds to a center of each of the abutment pin holes 110 formed in the tray body part 100. Alternatively, the cover part 130 may be in another shape different from the band shape.

Further, in an aspect of the present disclosure, as shown in FIG. 7, the pin insertion guide 133 of the synthetic resin film 131 may include a cut line part 133-1 formed by cutting the synthetic resin film 131 in a line shape from a top to a bottom or from the bottom to the top, or any other shape. Even when the pin insertion guide 133 is slightly pressed through an end or a bottom of the abutment pin 140, the pin insertion guide 133 may be cut or spread to guide the abutment pin 140 to be easily inserted into the abutment pin hole 110.

Further, the cut line part 133-1 may be formed by completely cutting the synthetic resin film 131 from the top to the bottom or from the bottom to the top through a knife or other cutting means. In the example, the cut line part 133-1 may have a thickness corresponding to an entire thickness of the synthetic resin film 131. Alternatively, the cut line part 133-1 may be formed to a depth of 0.5 mm when it is assumed that the thickness of the synthetic resin film 131 is 1 mm. In this case, the cut line part 133-1 located over the abutment pin hole 110 into which the abutment pin 140 is inserted is easily torn by the abutment pin 140, but the cut line part 133-1 located over another abutment pin hole 110 into which the abutment pin 140 is not inserted maintains the state that it is not completely cut, which makes it possible to more reliably block plaster from flowing into the abutment pin hole 110.

Furthermore, in another aspect of the present disclosure, as shown in FIG. 7, the cover part 130 may be implemented in various manners. As illustrated in FIG. 7, in one implementation, the cut line part 133-1 may be formed in a straight-line shape crossing a center of the abutment pin hole 110.

Further, in another aspect of the present disclosure, the cut line part 133-1 is formed in a shape crossing the center of the abutment pin hole 110. As illustrated in FIG. 7, however, the cut line part 133-1 may be formed in various shapes including a wave shape while crossing the abutment pin hole 110. Further, when the cut line part 133-1 has a shape of ‘−’, a portion corresponding to the cut line part 133-1 may be torn into two upper and lower portions. Furthermore, when the cut line part 133-1 has a shape of ‘+’, the portion corresponding to the cut line part 133-1 may be torn into four upper-lower and left-right portions. That is, the portion corresponding to the cut line part 133-1 may be torn into two or more parts by the cut line part 133-1 of the pin insertion guide 133, which is formed by cutting the synthetic resin film 131 in a vertical direction.

As such, when the lower portion of the abutment pin 140 (e.g., a lower portion of a pin body 141) is inserted into an entrance of the abutment pin hole 110, the cut line part 133-1 may be deformed in a shape tilted toward an inner circumference of the abutment pin hole 110 from the center of the abutment pin hole 110 in a same direction as the abutment pin 140.

FIGS. 8A to 8C illustrates a process of inserting an abutment pin into an abutment pin hole. As shown in FIGS. 8A and 8B, when the abutment pin 140 is placed downward on a synthetic resin film 131 (for example, make a contact with and press down the synthetic resin film 131), the synthetic resin film 131 is deformed, opening a passage for the abutment pin 140. In the example, the synthetic resin film 131 is positioned over the pin hole expansion portion 111 formed at the top of the abutment pin hole 110, and thus prevents an interference with the abutment pin 140 which is continuously inserted into the abutment pin hole 110. When the abutment pin 140 is completely inserted into the abutment pin hole 110, as shown in FIG. 8C, a torn portion of the cut line part 133-1 may be prevented from being caught between the abutment pin 140 and the abutment pin hole 110 because of the space 137 formed by the pin hole expansion portion 111. As a result, a state that the abutment pin 140 may be fitted into the correct position is maintained, thereby enabling making of a stable plaster model tooth.

Referring back to FIG. 8C, the abutment pin 140 supports a portion to be covered with a prosthesis through a plaster model tooth such that a prosthesis operation can be easily performed. As such, a state that the abutment pin 140 is inserted to a predetermined depth in the abutment pin hole 110 through the cover part 130 may be maintained.

In the example, the abutment pin 140 may include a pin body 141 and a pin head 142 formed at a top of the pin body 141, having a smaller cross-sectional area than the pin body 141, and being extended upward by a predetermined length. The pin body 141 and the pin head 142 may be formed as separate bodies or may be formed as one integral body. Further, the pin body 141 may be formed in a tapered shape of which a cross-sectional area gradually decreases from its top to its bottom. When the pin body 141 is inserted into the abutment pin hole 110 having the same shape, the pin body 141 may be prevented from being inserted to a predetermined depth or more in the abutment pin hole 110 depending on a diameter of the tapered shape, which may facilitate easy separation from the abutment pin hole 110. That is, the lower end portion of the pin body 141 may be exposed by a predetermined length from a bottom of the abutment pin hole 110 when the lower end portion of the pin body 141 completely passes through the abutment pin hole 110. Thus, when an exposed portion is pressed in a reverse direction from the bottom to the top of the tray body part 100, the pin body 141 can be easily separated.

In the example, the pin body 141 includes a circular cross-sectional shape. However, as illustrated in FIGS. 2 and 6 above, the pin body 141 may be in a different shape including any one of a circular cross-sectional shape, an elliptical cross-sectional shape or a polygonal cross-sectional shape. When the pin body 141 has a circular cross-sectional shape, the operator can easily insert the abutment pin 140 by simply inserting the pin body 141 into the abutment pin hole 110 regardless of the direction of the pin body 141 from a viewpoint of the abutment pin hole 110. However, when the pin body 141 is rotated in the center of the abutment pin hole 110 after being inserted into the abutment pin hole 110, the position of the abutment may be changed. On the other hand, when the pin body 141 has an elliptical or a polygonal cross-sectional shape, such as 140′ or 140″ (in FIG. 2), the pin body 141 may not be rotated after being inserted into the correct position of the abutment pin hole 110, which makes it possible to maintain the correct position. The pin body 141 may be formed in a tapered shape of which the cross-sectional area gradually decreases from top to bottom.

In an aspect of the present disclosure, the pin head 142 may include a plurality of pin head grooves 142-1 arranged at predetermined intervals from its top to its bottom or from its bottom to its top along the circumference thereof. The pin head grooves 142-1 may be configured to prevent a slip when the operator holds the pin head 142 with his hand and inserts the abutment pin 140 into the abutment pin hole 110. Thus, the plaster teeth model can be hardened while being stably supported.

In the present embodiment, the number of pin insertion guides 133 formed in the synthetic resin film 131 may correspond to the number of abutment pin holes 110 formed in the tray body part 100, and the pin insertion guide 133 may be torn in a shape having the shortest length from an inner circumferential portion to the opposite inner circumferential portion. Then, the state that the torn portion is inserted into the pin hole expansion portion 111 formed at the entrance of the abutment pin hole 110 can be continuously maintained to prevent an occurrence of interference.

Further, as illustrated in the bottom of FIG. 7, however, the pin insertion guide 133 may include a film cut part 133-2 formed by cutting the synthetic resin film 131 in the vertical direction along the edge of the abutment pin hole 110, and a film non-cut part 133-1 corresponding to a portion which is not cut in the portion corresponding to the abutment pin hole 110. In this case, before inserting the abutment pin 140 into the abutment pin hole 110, the operator may partially tear the synthetic resin film 131 by pushing the film cut part 133-2 from top to bottom in the abutment pin hole 110, completely cut the film non-cut part 133-1 by pulling the torn portion, and put the abutment pin 140 in the abutment pin hole 110. By doing so, since the state that the synthetic resin film 131 is completely removed is maintained above the entrance of the abutment pin hole 110, the abutment pin 140 may be easily inserted, and plaster can be prevented from flowing into another abutment pin hole 110 by the corresponding pin insertion guide 133 which is not removed.

Furthermore, pairs of the film cut part 133-2 and the film non-cut part 133-1 may be repeatedly formed to facilitate the separation. In the example, the film cut part 133-2 may have a circumferential length less than a half of the circumferential length of the abutment pin hole 110. When the circumferential length of the film cut part 133-2 is equal to or more than the half of the circumferential length of the abutment pin hole 110, the film cut part 133-2 may be completely torn from the beginning. In this case, when the film cut part 133-2 is separated during a process of storing and carrying the lower tray, the plaster may flow into the abutment pin hole 110. Therefore, the circumferential length of the film cut part 133-2 may be set to be less than the half of the circumferential length of the abutment pin hole 110.

FIGS. 9 and 10 illustrate a side cross-sectional view illustrating the abutment pins 140 coupled to the articulator lower tray B, while the articulator upper tray A and the articulator lower tray B are coupled and in an unfolded state in an aspect of the present disclosure. Further, FIG. 10 illustrates that an abutment pin is inserted into the articulator lower tray A through the cover part 130 and a plaster teeth model between the articulator lower tray A and the articulator upper tray B coupled together to each other.

In an aspect of the present disclosure, a pin body 141 of an abutment pin 140 may be positioned under the synthetic resin film 131. FIGS. 11 and 12 illustrates that the articulator lower tray A and the articulator upper tray B are coupled to each other with a plurality of abutment pins 140 disposed on the cover part 130. In the example, however, the pin body 141 of the abutment pin 140 may be exposed above a cut line part 133-1 formed in the synthetic resin film 131. In this case, the plaster can be prevented from flowing into under the cut line part 133-1 such that the abutment can be easily separated.

In an aspect of the present disclosure, the articulator lower tray A may include the cover part 130 made of a synthetic resin film and formed over the plurality of abutment pin holes formed at the top surface of the tray body part 100, thereby preventing a part of plaster from flowing into the abutment pin holes 110 during a process of obtaining a plaster teeth model. As mentioned above, the articulator lower tray A may prevent a part of plaster from flowing into the abutment pint holes 110 and hardening therein, thereby preventing a crack and a partial damage caused by the crack during a process of separating a hardened plaster tooth model. Thus, the plaster teeth model can be easily separated.

Also, since the plaster teeth model can be re-coupled to a correct position at the top surface of the tray body part 100, a more precise prosthesis can be obtained. As a result, the articulator lower tray A may increase the workability and productivity while minimizing an occurrence of a defective prosthesis.

While various examples or embodiments have been described above, it will be understood to those skilled in the art that the embodiments described are by way of example only. Accordingly, the disclosure described herein should not be limited based on the described embodiments or examples. While for the purpose of simplicity, the methodologies are described herein as a series of steps or acts, it is to be understood that the claimed subject matter is not limited by the order of steps or acts, as some steps or acts may occur in different orders and/or concurrently with other acts from that shown and described herein. Further, not all illustrated steps or acts may be required to implement various methodologies according to the present technology disclosed herein. Furthermore, the methodologies disclosed herein and throughout this specification are capable of being stored on an article of manufacture to facilitate transporting and transferring such methodologies to one or more processing systems. The term “article of manufacture” is intended to encompass a computer program accessible from any computer-readable device, carrier, or medium. A singular form may include a plural form if there is no clearly opposite meaning in the context. Also, as used herein, the article “a” is intended to include one or more items. Further, no element, act, step, or instruction used in the present disclosure should be construed as critical or essential to the present disclosure unless explicitly described as such in the present disclosure. As used herein, except explicitly noted otherwise, the term “comprise” and variations of the term, such as “comprising,” “comprises,” and “comprised” are not intended to exclude other additives, components, integers or steps. The terms “first,” “second,” and so forth used herein may be used to describe various components, but the components are not limited by the above terms. The above terms are used only to discriminate one component from other components, without departing from the scope of the present disclosure. Also, the term “and/or” as used herein includes a combination of a plurality of associated items or any item of the plurality of associated items. Further, it is noted that when it is described that an element is “coupled” or “connected” to another element, the element may be directly coupled or directly connected to the other element, or the element may be coupled or connected to the other element through a third element. A singular form may include a plural form if there is no clearly opposite meaning in the context. In the present disclosure, the term “include” or “have” as used herein indicates that a feature, an operation, a component, a step, a number, a part or any combination thereof described herein is present. Further, the term “include” or “have” does not exclude a possibility of presence or addition of one or more other features, operations, components, steps, numbers, parts or combinations. Furthermore, the article “a” as used herein is intended to include one or more items. Moreover, no element, act, step, or instructions used in the present disclosure should be construed as critical or essential to the present disclosure unless explicitly described as such in the present disclosure.

Although the present technology has been illustrated with specific examples described herein for purposes of describing example embodiments, it is appreciated by one skilled in the relevant art that a wide variety of alternate and/or equivalent implementations may be substituted for the specific examples shown and described without departing from the scope of the present disclosure. As such, the present disclosure is intended to cover any adaptations or variations of the examples and/or embodiments shown and described herein, without departing from the spirit and the technical scope of the present disclosure.

What is claimed is:

1. An articulator lower tray, comprising:
a tray body part having a plurality of abutment pin holes formed at an interval therein;
a plurality of abutment support protrusion parts formed at either side of the abutment pin holes of the tray body part; and
a cover part configured to cover tops of the plurality of abutment pin holes disposed between the abutment support protrusion parts.

2. The articulator lower tray of claim 1, further comprising one or more abutment pins configured to be inserted through the cover part into the plurality of abutment pin holes.

3. The articulator lower tray of claim 1, wherein the tray body part comprises:
a locking guide formed at one side thereof so as to protrude in a horizontal direction, and
a finger hinge part formed at the other side thereof so as to protrude in an obliquely upward direction, the locking guide having a locking hole into which an occlusion induction pin is inserted.

4. The articulator lower tray of claim 3, wherein the finger hinge part comprises:
a hinge finger support piece formed at the other side of the tray body part and protruding in the horizontal direction;
a hinge insertion finger supported by one of outer corners of the hinge finger support piece, inclined in an obliquely upward direction, and having a hinge insertion groove formed at the top thereof, wherein the hinge insertion groove is formed by cutting the upper portion of the hinge insertion finger; and
a hinge finger supported by the other of the outer corners of the hinge finger support piece, inclined in an obliquely upward direction, and having a cap hinge and finger stopper formed at the top thereof.

5. The articulator lower tray of claim 4, wherein the hinge finger support piece has a stop induction groove formed between the hinge insertion finger and the hinge finger.

6. The articulator lower tray of claim 1, wherein the abutment pin hole has a cross-sectional surface of which the area gradually decreases from a top toward a bottom thereof, and the abutment pin hole includes a pin hole expansion portion formed at the edge of an upper entrance thereof.

7. The articulator lower tray of claim 1, wherein the abutment pin hole includes any one cross-sectional surface among a circular cross-sectional surface, an elliptical cross-sectional surface and a polygonal cross-sectional surface, and the cross-sectional surface has an area that gradually decreases from a top toward a bottom thereof.

8. The articulator lower tray of claim 1, wherein the abutment support protrusion part is formed in a liner shape connected from the abutment pin hole at one side to the abutment pin hole at the other side, or composed of a plurality of pieces arranged in the same intervals as the abutment pin holes.

9. The articulator lower tray of claim 1, wherein the cover part comprises a synthetic resin film.

10. The articulator lower tray of claim 1, wherein the cover part is disposed on a top surface of the tray body part having the abutment pin holes formed therein through an adhesive layer formed on the bottom of the synthetic resin film.

11. The articulator lower tray of claim 9, wherein the cover part includes a plurality of pin insertion guides formed in the synthetic resin film having a band shape, and matched with a center of each of the abutment pin holes formed in the tray body part.

12. The articulator lower tray of claim 11, wherein each of the pin insertion guides comprises a cut line part formed by cutting the synthetic resin film in a vertical direction.

13. The articulator lower tray of claim 12, wherein the cut line part includes a line or wave shape crossing a portion located over a corresponding abutment pin hole.

14. The articulator lower tray of claim 11, wherein the pin insertion guide of the cover part is configured to be torn into two or more portions through the cut line part.

15. The articulator lower tray of claim 11, wherein the pin insertion guide of the cover part comprises:
a film cut part formed by cutting the synthetic resin film in the vertical direction along an edge of the abutment pin hole; and
a film non-cut part corresponding to a portion which is not cut in a corresponding portion of the synthetic resin film.

16. The articulator lower tray of claim 15, wherein pairs of the film cut part and the film non-cut part are repeatedly formed, and the film cut part has a circumferential length less than a half of the circumferential length of the abutment pin hole.

17. The articulator lower tray of claim 1, wherein the abutment pin comprises:
a pin body; and
a pin head formed at a top of the pin body, having a smaller cross-sectional area than the pin body, and extended upward by a predetermined length, wherein the pin body and the pin head are formed as one body.

18. The articulator lower tray of claim 17, wherein the pin body is formed in a shape of which the cross-sectional area gradually decreases from a top toward a bottom thereof.

19. The articulator lower tray of claim 17, wherein the pin body includes any one cross-sectional shape among a circular cross-sectional shape, an elliptical cross-sectional shape and a polygonal cross-sectional shape, and the pin body is formed in a shape of which a cross-sectional area gradually decreases from a top toward a bottom thereof.

20. The articulator lower tray of claim 17, wherein the pin head is configured to include a plurality of pin head grooves formed at a predetermined interval from a top toward a bottom thereof or from the bottom toward the top along a circumference thereof.
